(19) United States
(12) Patent Application Publication
(10) Pub. No.: US 2014/0143979 A1
(43) Pub. Date: May 29, 2014

(54) Sliding member, in particular for a door closer

(71) Applicant: Bernd Winkler, Breckerfeld (DE)

(72) Inventor: Bernd Winkler, Breckerfeld (DE)

(21) Appl. No.: 14/131,384

(22) PCT Filed: May 30, 2012
(86) PCT No.: PCT/EP2012/002281

§ 371 Date: Jan. 7, 2014

(30) Foreign Application Priority Data
Jul. 8, 2011 (DE) 10 2011 051 668.9

(51) Int. Cl. E05F 3/22

(52) U.S. Cl. CPC E05F 3/22
USPC 16/71

(57) ABSTRACT

A sliding member for a door closer that is operatively connected to the sliding member by a lever arm. The sliding member includes: a body, having two sliding surfaces disposed at opposite lateral surfaces of the body; an adapter member, configured to be connectable to the lever arm; and an insert configured to be inserted into the body to accommodate the adapter member. The insert is retained in the body in an exchangeable manner and has at least one unlatching geometrical device adapted to absorb forces of a held-open device without damage.

### CROSS-REFERENCE TO RELATED APPLICATIONS

This is a U.S. national stage of application No. PCT/EP2012/002281, filed on 30 May 2012, which claims priority to the German Application No. 10 2011 051 668.9, filed 8 Jul. 2011, the content of both incorporated herein by reference.

### BACKGROUND OF THE INVENTION

1. Field of the Invention The present invention relates to a sliding member, in particular for a door closer, which door closer, on account of a lever arm, is operatively connected to the sliding member, wherein the sliding member has a body, which has two sliding surfaces disposed at two opposite lateral surfaces of the body.

2. Related Art Such sliding members are utilized in sliding channels, which cover door sizes from EN 2 to EN 5, wherein the sliding members are made from plastic material, wherein a multitude of variants exists, in order to be able to equip the individual door sizes with an appropriate sliding member.

Such sliding members have a disadvantage in that they might be damaged when being used with doors having the size EN 6 to EN 7, because they cannot resist the action of forces generated by the electromagnetic hold-open device. On account of the surface pressure between a blocking element of the electromagnetic hold-open device and the inside contour of the sliding member, the plastic material of the sliding member may begin to flow such that the hold-open effect of the door is no longer guaranteed.

Another disadvantage is that with doors having the size EN 6 or EN 7, while utilizing existing sliding members, the electromagnetic hold-device would have to be exchanged, so that the existing sliding member would be subject to lower forces. However, exchanging the electromagnetic hold-open device would result in a stronger and larger embodiment of the electromagnetic hold-open device with respect to the constructional size. Moreover, the hold-open device would require a larger sliding channel, which, however, should be avoided on account of the multiplicity of variants as well as for visual reasons.

### SUMMARY OF THE INVENTION

Therefore, it is the object of the invention to provide a sliding member, which deals with the current disadvantages, that can be manufactured inexpensively and is easy to install.

This problem is solved, according to an aspect of the invention, with a sliding member, in particular for a door closer, wherein the door closer, on account of a lever arm, is operatively connected to the sliding member, wherein the sliding member has a body having two sliding surfaces disposed at opposite lateral surfaces of the body, in that an insert for the reception of an adapter member, which is connectable to the lever arm, is inserted into the body, wherein the insert presents at least one unlatching geometrical device and is retained in the body in an exchangeable manner.

In one aspect, the insert is configured so as to be retained in the body in an exchangeable manner, whereby the sliding member is proposed according to a modular set system. Depending on the required EN size, an appropriate insert can be disposed in the sliding member.

On account of the exchangeability of the insert, according to an aspect of the invention, the inserts are configured to be utilized in a different manner, wherein an unlatching geometrical device is affixed to the respective inserts depending on the different EN sizes and the electromagnetic hold-open device absorbs the generated forces of the electromagnetic hold-open device in such a way that the unlatching geometrical devices of the respective insert remain damage-free.

According to an advantageous further development, according to an aspect of the invention, the body is configured to be integral with the two sliding surfaces. On account of this configuration, the inventive sliding member consists of only a few individual parts and is therefore easy to manufacture.

It is particularly advantageous aspect, the body and the sliding surfaces consist of thermoplastic material, because this material has good sliding characteristics.

Homo-polymer has proven to be particularly suitable as such a thermoplastic material, because it has a low friction coefficient, which ensures good sliding characteristics of the sliding member within the sliding channel. In this case, in particular, the surfaces of the sliding member are of importance, which are in communication with the sliding channel.

According to a preferred embodiment, in one aspect the insert consists of metal and is preferably configured as a metal-powder injection moulding part. On the one side, the insert can thus be easily and simply manufactured and, on the other side, it has a sufficient strength for receiving the adapter member, the insert having high wear-resistance.

Advantageously, according to one aspect, the body has a U-shaped cross-section. On the one hand, this shape ensures a good seating of the body in the sliding channel and, on the other hand, a reliable reception of the insert in the body.

According to an advantageous further development, in one aspect the insert has mounting shapes abutting against lateral portions of the U-shaped cross-section. These mounting shapes assist in exchanging the insert, allowing a quick installation to be accomplished.

It is furthermore advantageous, according to an aspect of the invention, if the body has reception shapes, which correspond to the mounting shapes of the insert. This measure ensures positioning of the insert in the body, guaranteeing a reliable retaining of the insert in the body.

It is likewise advantageous, according to an aspect of the invention, if the unlatching geometrical devices are disposed at legs of the insert. This ensures cooperation of the electromagnetic hold-open device and the sliding member in a simple manner.

It is advantageous, according to an aspect of the invention, if the unlatching geometrical device includes inclines, such that the inclines affect the required unlatching force. The electromagnetic hold-open device cooperates positively and non-positively with the sliding member, such that, on account of differently configured inclines, the influence of force, which is generated by the electromagnetic hold-open device, can be affected by configuring the inclines to be flatter or steeper.

It is likewise advantageous according to an aspect of the invention, if the unlatching force can be influenced depending on the differently configured inclines. Thus different door sizes can be equipped with one sliding member, wherein an appropriate insert having the appropriate unlatching geometrical device needs to be selected. This will reduce the number of parts.

Another advantage according to an aspect of the invention, is, if each embodiment of an insert includes differently configured inclines. This allows one insert to be associated to each door size.

Preferably, according to an aspect of the invention, the insert is retained in the body in an exchangeable manner, in order to be able to respond to equipping different door sizes in a flexible manner.

### BRIEF DESCRIPTION OF THE DRAWINGS

Further details, features and advantages of the invention will become apparent from the following description, reference being made to the drawings, in which:

FIG. 1 is an exploded perspective view of the inventive sliding member;

FIG. 2 is a perspective view of an assembled sliding member according to an embodiment of the invention; and

FIG. 3 is a top view of an embodiment of the insert.

### DETAILED DESCRIPTION OF THE PRESENTLY PREFERRED EMBODIMENTS

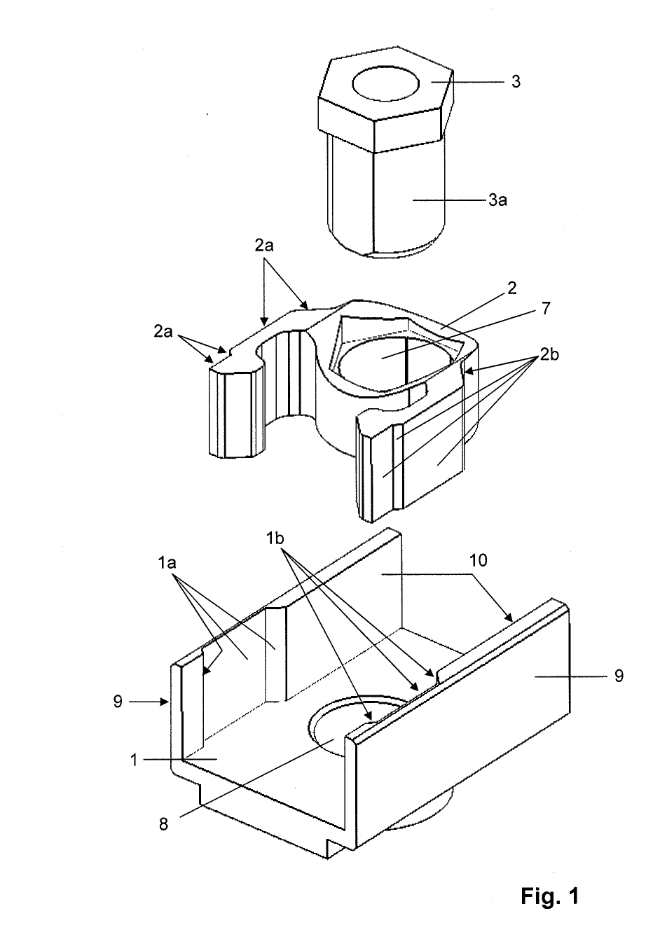

The sliding member illustrated in FIG. 1, which can be preferably utilized in conjunction with a door closer, consists of a body 1, an insert 2, which is insertable into the body 1, and an adapter member 3, which is preferably configured as a turned part, can be introduced into the insert 2, and serves as the connection to a non-illustrated lever arm of a door closer, wherein the shaft 3a of the adapter member 3 passes through the bore 7 of the insert 2 and reaches into the bore 8 of the body 1.

In cross-section, the body 1 is configured to be essentially U-shaped, wherein the two lateral webs of the U form sliding surfaces 9 on their exterior sides, by which the sliding member is guided in a non-illustrated sliding channel. At its interior surfaces 10, the body 1 has reception shapes 1a, 1b, which cooperate with the mounting shapes 2a, 2b of the insert 2 in such a way that the insert 2 is retained in the body 1. The body 1 is configured to be integral with the sliding surfaces 9 and consists of a thermoplastic material, preferably of a homo-polymer such Delrin.

The insert 2, which consists, for example, of metal and is preferably configured as a metal-powder injection moulding part, has mounting shapes 2a, 2b, which, in the inserted condition, positively cooperate with the reception shapes 1a, 1b such that the insert 2 is reliably retained in the body 1.

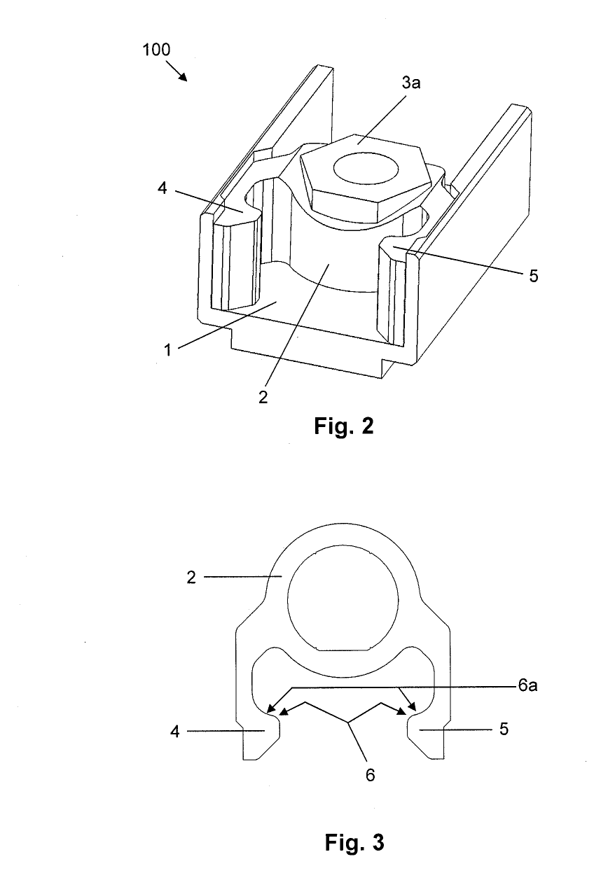

The sliding member 100 is illustrated in the assembled condition in FIG. 2, wherein the insert 2 is disposed in such a way at a portion of the body 1 that the reception shapes 1a, 1b of the body 1 positively correspond to the mounting shapes 2a, 2b of the insert 2, such that the insert 2 is reliably retained in the body 1. On account of the shaft 3a, the adapter member 3 is operatively connected to the insert 2 and to the body 1. The insert 2 is provided with unlatching geometrical devices 6, which are disposed at the first leg 4 and at the second leg 5.

FIG. 3 shows the insert 2 with its first leg 4 and its second leg 5, wherein the unlatching geometrical devices 6 are disposed at the legs 4, 5. In another insert 2, the unlatching geometrical devices 6 may have a different shape in such a way that the differing shape is adapted to the door sizes EN 2 to EN 7, wherein a single embodiment of the electromagnetic hold-open device is utilized for the door sizes EN 2 to EN 7.

The exchangeability of the insert 2 provides the option of keeping inserts 2 in stock in which the unlatching geometrical devices 6 are adapted to different EN door sizes. In this case, depending on the application case, the inclines 6a of the unlatching geometrical device 6 for different embodiments of the insert 2 are configured to be more slanted or steeper, which affects the action of forces which are exerted by the electromagnetic hold-open device on the sliding member 100.

Thus, depending on the configured unlatching geometrical device 6 of an insert 2 and the electromagnetic hold-open device, in conjunction with one respective EN size of a door, a reliable hold-open device can be guaranteed.

The insert 2 can be directly configured as the body. In this case, the two surfaces 9, which ensure the sliding ability within the sliding channel, are made from plastic material. The two surfaces, which consist of plastic material, are, for example, individual structural members and can be attached to the body by a clip, such that the unlatching geometrical devices 6 are affixed to the first leg 4 and the second leg 5.

The preceding description of the present invention serves for illustrative purposes only and is not intended to limit the invention. Various changes and modifications are possible within the range of the invention without leaving the scope of the invention or the equivalents thereof.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-12. (canceled)

13. A sliding member (100), for a door closer, the door closer being operatively connected to the sliding member (100) by a lever arm, the sliding member (100) comprising:
a body (1) having two sliding surfaces (9) disposed at opposite lateral surfaces of the body (1);
an adapter member (3) configured to be connectable to the lever arm; and
an insert (2) configured to be inserted into the body (1) to accommodate the adapter member (3), the insert (2) being retained in the body (1) in an exchangeable manner and having at least one unlatching geometrical device (6a, 6b) adapted to absorb forces of a held-open device without damage.

14. The sliding member (100) according to claim 13, wherein the body (1) is configured to be integral with the two sliding surfaces (9).

15. The sliding member (100) according to claim 13, wherein the body (1) and the sliding surfaces (9) consist of a thermoplastic material.

16. The sliding member (100) according to claim 15, wherein the thermoplastic material is a homo-polymer

17. The sliding member (100) according to claim 13, wherein the insert (2) is made from metal and is preferably configured as a metal-powder injection molding part.

18. The sliding member (100) according to claim 13, wherein the body (1) has a U-shaped cross-section.

19. The sliding member (100) according to claim 18, wherein the insert (2) includes mounting shapes (2a, 2b), abutting against the lateral portions of the U-shaped cross-section, and/or the body (1) has reception shapes (1a, 1b), which correspond to the mounting forms (2a, 2b) of the insert (2) such that the insert (2) is retained in the body (1) via the mounting shapes (1a, 1b, 2a, 2b).

20. The sliding member (100) according to claim 13, wherein the at least one unlatching geometrical device (6) is disposed at legs (4, 5) of the insert (2).

21. The sliding member (100) according to claim 20, wherein the at least one unlatching geometrical device (6) includes inclines (6a), wherein the inclines (6a) affect the required unlatching force.
